(19) United States
(12) Patent Application Publication
(10) Pub. No.: US 2022/0215070 A1
(43) Pub. Date: Jul. 7, 2022

(54) INFORMATION ACQUISITION METHOD AND INFORMATION PROCESSING DEVICE

(71) Applicant: FUJITSU LIMITED, Kawasaki-shi (JP)

(72) Inventor: Masaki ARAI, Kawasaki (JP)

(73) Assignee: FUJITSU LIMITED, Kawasaki-shi (JP)

(21) Appl. No.: 17/483,004

(22) Filed: Sep. 23, 2021

(30) Foreign Application Priority Data
Jan. 5, 2021 (JP) 2021-000319

(51) Int. Cl. G06F 17/16; G06F 9/30; G06F 12/0862

(52) U.S. Cl. CPC G06F 17/16; G06F 12/0862; G06F 9/30036

(57) ABSTRACT

A non-transitory computer-readable recording medium stores an information acquisition program for causing a computer to execute a process, the process including receiving sparse matrix data that indicates a position of a non-zero element in a sparse matrix that is referred in sparse matrix processing included in a target program, and acquiring, using the sparse matrix data, cache access information that indicates an access status to a cache memory occurred in the sparse matrix processing.

### CROSS-REFERENCE TO RELATED APPLICATION

This application is based upon and claims the benefit of priority of the prior Japanese Patent Application No. 2021-000319, filed on Jan. 5, 2021, the entire contents of which are incorporated herein by reference.

### FIELD

The embodiment discussed herein is related to an information acquisition technique.

### BACKGROUND

High Performance Computing (HPC) application programs tend to have limited hotspots of the program. Therefore, even in a case where profile information is acquired to capture characteristics of a program, it is often sufficient that only some kernel loops be investigated.

Kernel loops of an HPC application program tend to access a large amount of data. In order to perform the kernel loops at high speed, it is desirable to effectively use a cache memory provided in a Central Processing Unit (CPU) of a computer.

In relation to the cache memory, an information processing device that acquires profile information regarding an access to the cache memory at high speed for each parallel processing execution method in a multithread program is known. A variable update device that acquires profile data for each cache set of the cache memory is also known.

A matrix calculation device that efficiently executes parallelization of matrix product calculation is also known. Various data formats used to handle sparse matrices are also known.

Japanese Laid-open Patent Publication No. 2018-124892, Japanese Laid-open Patent Publication No. 2014-232369, Japanese Laid-open Patent Publication No. 2019-148969, and Tomonori Kouya, “Introduction to LAPACK/BLAS”, Morikita Publishing Co., Ltd., p.81 to 88, 2016 are disclosed as related art.

### SUMMARY

According to an aspect of the embodiment, a non-transitory computer-readable recording medium stores an information acquisition program for causing a computer to execute a process, the process including receiving sparse matrix data that indicates a position of a non-zero element in a sparse matrix that is referred in sparse matrix processing included in a target program, and acquiring, using the sparse matrix data, cache access information that indicates an access status to a cache memory occurred in the sparse matrix processing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a flowchart of information acquisition processing;

FIG. 2 is a functional configuration diagram of an information processing device;

FIG. 3 is a diagram illustrating a program;

FIG. 4 is a diagram illustrating array information;

FIG. 5 is a diagram illustrating variable information;

FIG. 6 is a diagram illustrating cache configuration information;

FIG. 7 is a diagram illustrating components of a program;

FIG. 8 is a diagram illustrating a profile acquisition program;

FIG. 9 is a diagram illustrating sparse matrix information;

FIG. 10 is a diagram illustrating a sparse matrix generation program;

FIG. 11 is a diagram illustrating sparse matrix data;

FIG. 12 is a diagram illustrating a sparse matrix generation function used to generate a lower triangular sparse matrix;

FIG. 13 is a diagram illustrating a lower triangular sparse matrix;

FIG. 14 is a diagram illustrating a sparse matrix generation function used to generate an upper triangular sparse matrix;

FIG. 15 is a diagram illustrating an upper triangular sparse matrix;

FIG. 16 is a diagram illustrating a sparse matrix generation function used to generate a random sparse matrix;

FIG. 17 is a diagram illustrating a random sparse matrix;

FIG. 18 is a diagram illustrating a sparse matrix generation function used to generate a band matrix;

FIG. 19 is a diagram illustrating a band matrix;

FIG. 20 is a diagram illustrating a program;

FIG. 21 is a diagram illustrating sparse matrix information;

FIG. 22 is a diagram illustrating a sparse matrix generation program;

FIG. 23 is a diagram illustrating sparse matrix data;

FIG. 24 is a flowchart illustrating tuning processing;

FIG. 25 is a flowchart of program conversion processing; and

FIG. 26 is a hardware configuration diagram of an information processing device.

### DESCRIPTION OF EMBODIMENT

According to the information processing device in Japanese Laid-open Patent Publication No. 2018-124892, the profile information regarding the access to the cache memory for each parallel processing execution method may be acquired at high speed in a multithread program.

However, in a case where a sparse matrix is used in a matrix calculation included in an HPC application program, it is difficult to acquire profile information that reflects a data structure peculiar to the sparse matrix.

Note that such a problem occurs not only in HPC application programs but also in various programs including sparse matrix processing.

Hereinafter, an embodiment will be described in detail with reference to the drawings.

In a case where a dense matrix is used for matrix calculation included in an HPC application program, data of the dense matrix or a vector does not largely change an operation of a cache memory. Therefore, without considering an effect of the data, profile information regarding an access to the cache memory may be acquired and performance tuning of the application program may be performed so as to reduce cache misses.

It is desirable that the profile information used for the performance tuning include information that indicates in which memory access in the application program a cache miss occurs and information that indicates a cause of the cache miss.

However, there is a case where a sparse matrix is used for a matrix calculation. A sparse matrix is a matrix including a large number of zero elements and a small number of non-zero elements. The “zero element” represents an element of which a value is zero, and the “non-zero element” represents an element of which a value is not zero.

In an array storing data of a sparse matrix, data of a zero element is not explicitly held. Data indicating the value of a non-zero element and data indicating the position of the non-zero element in the sparse matrix are held. As a result, a data transfer amount between a memory and a CPU is reduced, and the application program may be executed at high speed.

In a case where a sparse matrix is used for the matrix calculation, source codes are complicated. Therefore, it is difficult to apply optimization by a compiler. Moreover, there is a possibility that an execution time of the application program largely changes according to a distribution state of non-zero elements in a sparse matrix or a vector.

Therefore, in an application program including matrix calculation using a sparse matrix, it is desirable to perform performance tuning in consideration of various distribution states of non-zero elements, and a performance tuning work is complicated.

According to the technique of Japanese Laid-open Patent Publication No. 2018-124892, the distribution state of non-zero elements in the sparse matrix is not reflected to the profile information. Therefore, it is difficult to perform performance tuning for efficiently using the cache memory. Furthermore, in an HPC application program, a size of a matrix often becomes huge, it is not realistic to prepare matrix data for the performance tuning.

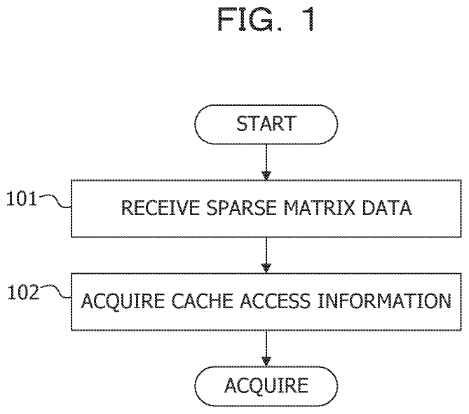

FIG. 1 is a flowchart illustrating an example of information acquisition processing executed by an information processing device (computer) according to the embodiment. The information processing device receives sparse matrix data that indicates a position of a non-zero element in a sparse matrix referred in sparse matrix processing included in a target program (step 101). Next, the information processing device acquires cache access information that indicates a status of an access to the cache memory occurred in the sparse matrix processing, using the sparse matrix data (step 102).

According to the information acquisition processing in FIG. 1, the status of the access to the cache memory in the sparse matrix processing may be acquired.

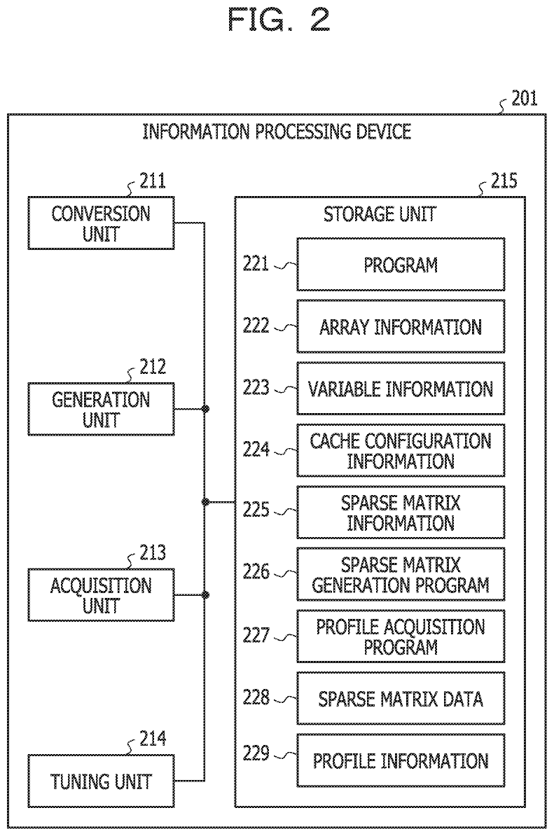

FIG. 2 illustrates a functional configuration example of the information processing device that executes the information acquisition processing in FIG. 1. An information processing device 201 in FIG. 2 includes a conversion unit 211, a generation unit 212, an acquisition unit 213, a tuning unit 214, and a storage unit 215.

The storage unit 215 stores therein a program 221 to be tuned, array information 222, variable information 223, cache configuration information 224, sparse matrix information 225, and a sparse matrix generation program 226.

The program 221 corresponds to the target program and is, for example, an HPC application program that executes information processing including sparse matrix processing using a parallel computer. The sparse matrix processing is processing that involves an access to an array representing a sparse matrix. The parallel computer that executes the program 221 may be the information processing device 201 or another information processing device.

The array information 222 is information regarding an array included in the program 221, and the variable information 223 is information regarding a variable that indicates a size of the sparse matrix included in the program 221. The cache configuration information 224 is information regarding a configuration of a cache memory included in the parallel computer that executes the program 221, and the sparse matrix information 225 is information regarding the sparse matrix included in the program 221. The sparse matrix generation program 226 is a program that generates sparse matrix data 228 from the sparse matrix information 225.

The conversion unit 211 converts the program 221 into a profile acquisition program 227 and stores the profile acquisition program 227 in the storage unit 215. The conversion unit 211 may convert the program 221 into the profile acquisition program 227, for example, using the techniques of Japanese Laid-open Patent Publication No. 2018-124892 and Japanese Laid-open Patent Publication No. 2014-232369. The profile acquisition program 227 corresponds to an information acquisition program.

By executing the profile acquisition program 227, the profile information 229 of the cache memory may be acquired using an address of an array referred through a memory access in a case where the parallel computer executes the program 221.

The profile information 229 corresponds to the cache access information and includes information indicating a memory access in which a cache miss occurs in the cache memory from among the plurality of memory accesses included in the program 221. Therefore, by acquiring the profile information 229, it is possible to verify a cache miss occurrence status in a case where the program 221 is executed.

The generation unit 212 executes the sparse matrix generation program 226 using the sparse matrix information 225 so as to generate the sparse matrix data 228 and stores the generated sparse matrix data 228 in the storage unit 215. The sparse matrix data 228 indicates a position of a non-zero element in the sparse matrix indicated by the sparse matrix information 225.

The acquisition unit 213 executes the profile acquisition program 227 using the array information 222, the variable information 223, the cache configuration information 224, and the sparse matrix data 228 so as to receive the sparse matrix data 228 and acquire the profile information 229. Then, the acquisition unit 213 stores the acquired profile information 229 in the storage unit 215. The acquisition unit 213 may execute the profile acquisition program 227, for example, using the techniques of Japanese Laid-open Patent Publication No. 2018-124892 and Japanese Laid-open Patent Publication No. 2014-232369.

The tuning unit 214 performs performance tuning of the program 221 using the profile information 229. In the performance tuning, for example, parameters such as the number of threads used for parallel processing, a chunk size of loop processing, or a type of a thread scheduling method, are determined.

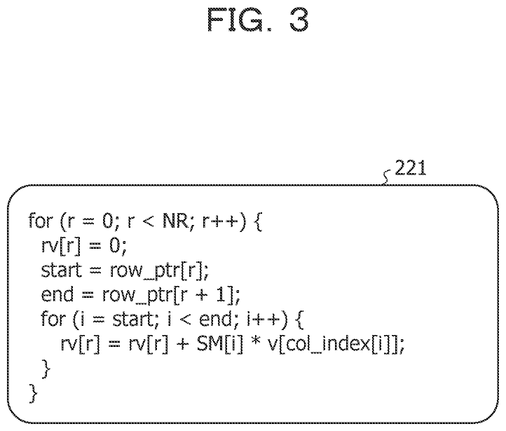

FIG. 3 illustrates a first example of the program 221. The program 221 in FIG. 3 includes a sparse matrix in a Compressed Sparse Row (CSR) format. In the CSR format, a sparse matrix is expressed using an array col_index indicating an index of a column of non-zero elements and an array row_ptr indicating a start position of each row in the array col_index.

The program 221 in FIG. 3 is a program that multiplies the sparse matrix expressed by the array row_ptr, the array col_index, and non-zero elements SM in the sparse matrix by a vector v. An array “rv” represents a result of multiplication of a sparse matrix by a vector.

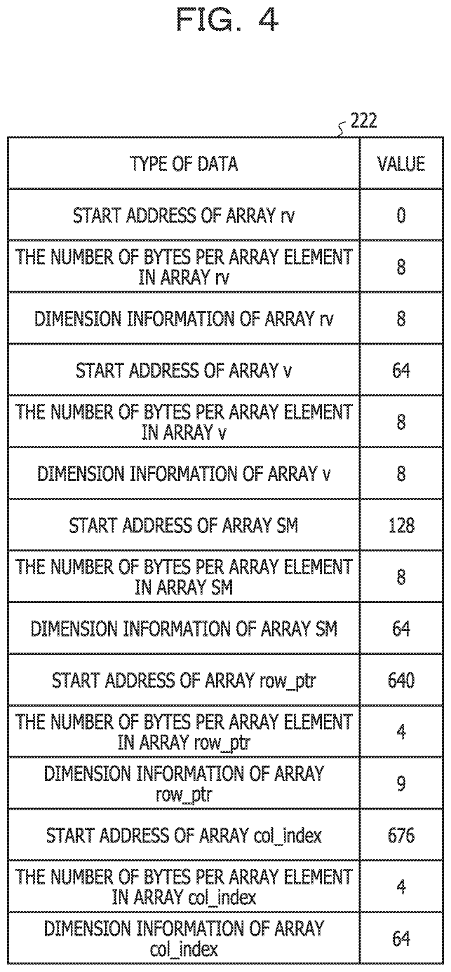

FIG. 4 illustrates an example of the array information 222 of an array included in the program 221 in FIG. 3. The array information 222 in FIG. 4 includes a start address, the number of bytes per array element, and dimension information of each of the array rv, the vector v, the non-zero elements SM in the sparse matrix, the array row_ptr, and the array col_index. The “start address” represents a start address of a region in a memory where data of an array is stored, the “number of bytes per array element” represents a data size of each element in the array, and the “dimension information” represents the number of elements of the array.

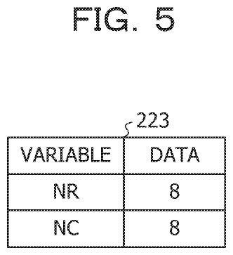

FIG. 5 illustrates an example of the variable information 223 that indicates the size of the sparse matrix included in the program 221 in FIG. 3. A variable “NR” represents the total number of rows of a sparse matrix, and a variable “NC” represents the total number of columns of the sparse matrix. The variable NR corresponds to the number of loop executions included in the program 221.

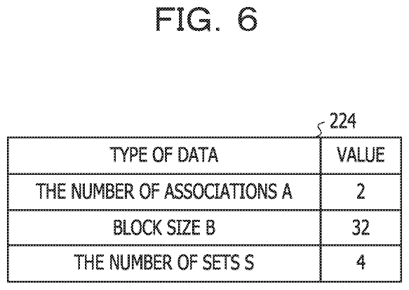

FIG. 6 illustrates an example of the cache configuration information 224 of the parallel computer that executes the program 221 in FIG. 3. The cache configuration information 224 in FIG. 6 includes the number of associations A, a block size B, and the number of sets S.

The “number of associations A” represents the number of associations of a cache memory included in the parallel computer, the “block size B (bytes)” represents a data size of a block of the cache memory, and the “number of sets S” represents the number of sets of the cache memory. Each set includes A blocks. The number of sets S is expressed by the following formula using a data size C (bytes) of the cache memory.

S=C/(A·B) (1)

In a case where the program 221 accesses data at an address a, a set number s of a set accessed in the cache memory is represented by the following formula.

s=floor(a/B)mod S (2)

The “floor(x)” represents the largest integer equal to or less than x, and the “mod” represents modulo calculation. In this way, the set number s corresponding to the address a may be obtained using the number of associations A, the block size B, and the number of sets S.

When the program 221 is converted into the profile acquisition program 227, the conversion unit 211 decomposes the program 221 into a plurality of components.

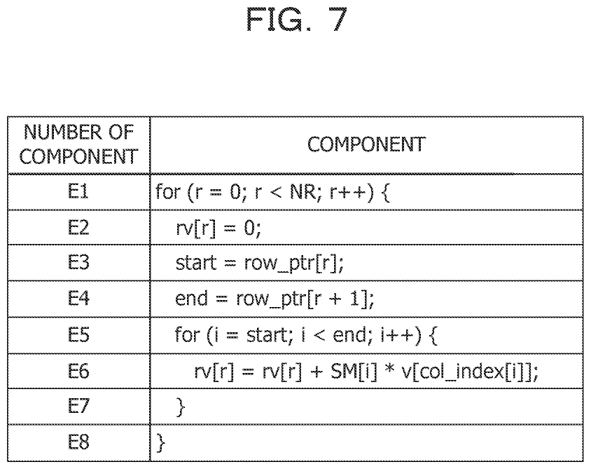

FIG. 7 illustrates an example of components of the program 221 in FIG. 3. The program 221 in FIG. 3 includes components E1 to E8. The components E1 and E5 correspond to start of a loop. The components E2 and E6 correspond to a first-class assignment statement that does not affect the number of loop executions and the memory access. The components E3 and E4 correspond to a second-class assignment statement that affects the number of loop executions and the memory access. The components E7 and E8 correspond to end of a loop.

The conversion unit 211 outputs the components corresponding to the start and the end of a loop as codes of the profile acquisition program 227, deletes the components corresponding to the first-class assignment statement, and outputs the components corresponding to the second-class assignment statement as codes.

In a case where the components corresponding to the first-class assignment statement are deleted, the conversion unit 211 outputs a code indicating processing for executing a library function “ACCESS(s, a)” described in Japanese Laid-open Patent Publication No. 2014-232369 for each term that refers to an element of an array included in the component. In a case where the components corresponding to the second-class assignment statement are output, the conversion unit 211 outputs a code indicating processing for executing ACCESS(s, a) for each term that refers to an element of an array included in the component.

The ACCESS(s, a) is a library function that simulates an access to the cache memory using the cache configuration information 224. In a case where a set having a set number s in the cache memory is accessed through a memory access to an address a, ACCESS(s, a) simulates an operation for accessing the set having the set number s using the address a. Then, ACCESS(s, a) records an access result indicating hit or miss.

By outputting the code indicating the processing for executing ACCESS(s, a), the detailed profile information 229 of the cache memory may be acquired.

After the processing on all the components is completed, the conversion unit 211 outputs the code “DUMP(s)” described in Japanese Laid-open Patent Publication No. 2014-232369. The DUMP(s) is a code that outputs the profile information 229 regarding a set having a set number s in the cache memory.

First, the conversion unit 211 processes the component E1. Because the component E1 corresponds to the start of a loop, the component E1 is output.

Next, the conversion unit 211 processes the component E2. Because the component E2 corresponds to the first-class assignment statement, the component E2 is deleted without being output, and a code indicating processing for executing ACCESS(s, address(rv[r])) on a term rv[r] included in the component E2 is output. The “address(rv[r])” represents processing for acquiring an address of an element rv[r] of the array rv. For example, in a case where the program 221 is written in C language, address(rv[r]) may be implemented using an operator “&”.

Next, the conversion unit 211 processes the component E3. Because the component E3 corresponds to the second-class assignment statement, the component E3 is output, and a code indicating processing for executing ACCESS(s, address(row_ptr[r])) on a term row_ptr[r] included in the component E3 is output. The “address(row_ptr[r])” represents processing for acquiring an address of an element row_ptr[r] in the array row_ptr.

Next, the conversion unit 211 processes the component E4. Because the component E4 corresponds to the second-class assignment statement, the component E4 is output, and a code indicating processing for executing ACCESS(s, address(row_ptr[r+1])) on a term row_ptr[r+1] included in the component E4 is output. The “address(row_ptr[r+1])” represents processing for acquiring an address of an element row_ptr[r+1] in the array row_ptr.

Next, the conversion unit 211 processes the component E5. Because the component E5 corresponds to the start of a loop, the component E5 is output.

Next, the conversion unit 211 processes the component E6. Because the component E6 corresponds to the first-class assignment statement, the component E6 is deleted without being output, and the following codes are output for each term included the component E6.

ACCESS(s, address(rv[r])); ACCESS(s, address(SM[i])); ACCESS(s, address(col_index[i])); ACCESS(s, address(v[col_index[i]])); ACCESS(s, address(rv[r]));

These codes indicate the processing for executing the library function ACCESS(s, a). The “address(SM[i])” represents processing for acquiring an address of an element SM[i] in the non-zero elements SM in the sparse matrix. The “address(col_index[i])” represents processing for acquiring an address of an element col_index[i] in the array col_index. The “address(v[col_index[i]])” represents processing for acquiring an address of an element v[col_index[i]] in the vector v.

By adding these codes, a code for referring to a non-zero element in a sparse matrix is replaced with a code for simulating the access to the cache memory. As a result, the profile information 229 of the cache memory in the sparse matrix processing may be easily acquired.

Next, the conversion unit 211 processes the component E7. Because the component E7 corresponds to the end of a loop, the component E7 is output.

Next, the conversion unit 211 processes the component E8. Because the component E8 corresponds to the end of a loop, the component E8 is output. Finally, the conversion unit 211 outputs the code DUMP(s) and ends the processing.

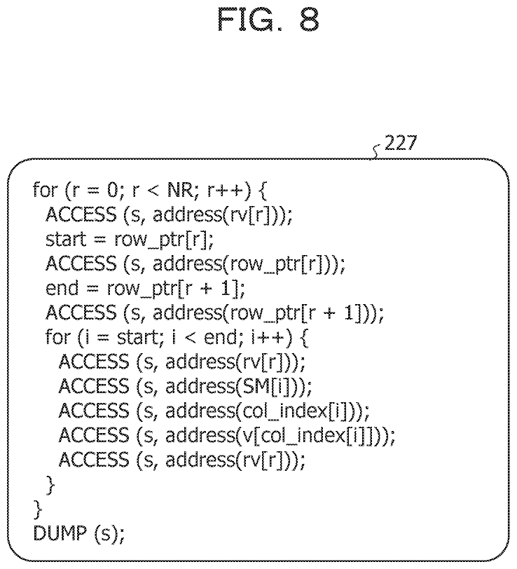

FIG. 8 illustrates an example of the profile acquisition program 227 generated from the program 221 in FIG. 3. The profile acquisition program 227 in FIG. 8 includes the codes output from the conversion unit 211.

By deleting the components E2 and E6, substitution processing and calculation processing that do not affect the number of loop executions and the memory access are omitted. As a result, the execution time of the profile acquisition program 227 may be shortened than the execution time of the program 221.

When acquiring the profile information 229, the acquisition unit 213 executes the profile acquisition program 227 in parallel for all the set numbers s. As a result, because simulations are performed with respect to the plurality of sets of the cache memory in parallel, the profile information 229 for the sets may be acquired at high speed.

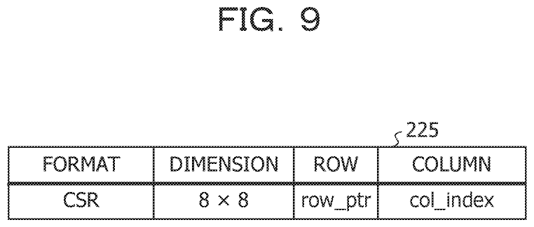

FIG. 9 illustrates a first example of the sparse matrix information 225. The sparse matrix information 225 in FIG. 9 represents a sparse matrix in the CSR format included in the program 221 in FIG. 3. The “format” represents a data format of a sparse matrix, the “dimension” represents a size of a sparse matrix, the “row” represents an array indicating a row including a non-zero element, and the “column” represents an array indicating a column including a non-zero element. In this example, the format is the CSR, the dimension is 8×8, the row is row_ptr, and the column is col_index.

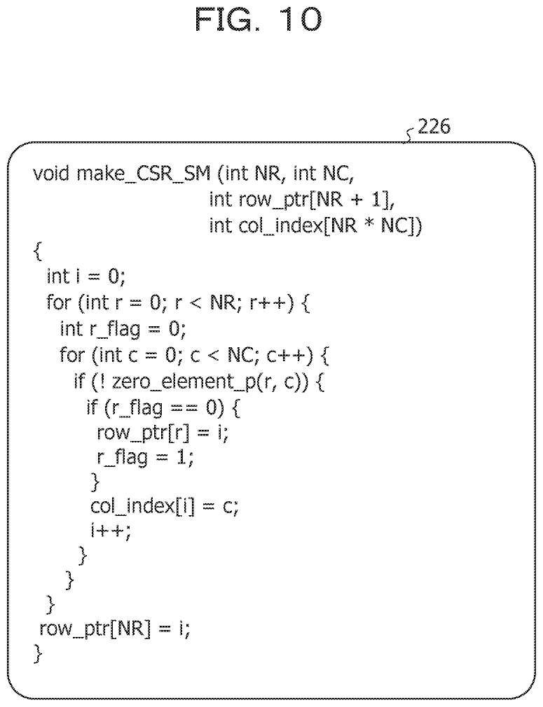

FIG. 10 illustrates a first example of the sparse matrix generation program 226. The sparse matrix generation program 226 in FIG. 10 is a program that generates the sparse matrix data 228 in the CSR format. The sparse matrix data 228 in the CSR format is represented using the array row_ptr and the array col_index.

The sparse matrix generation program 226 in FIG. 10 is a program that determines which one of a zero element or a non-zero element each element in a sparse matrix having NR rows and NC columns is set to, and records positions of non-zero elements in the array row_ptr and the array col_index. In the processing for executing the library function ACCESS(s, a), only the position of a non-zero element is used, and a value of the non-zero element is not used. Therefore, the value of the non-zero element is not generated.

The function zero_element_p(r, c) included in the sparse matrix generation program 226 in FIG. 10 is a sparse matrix generation function that determines which one of a zero element and a non-zero element is set in a sparse matrix at the r-th row and the c-th column. In a case where the value of zero_element_p(r, c) is true (logical value “1”), the element at the r-th row and the c-th column is determined as a zero element, and in a case where the value of zero_element_p(r, c) is false (logical value “0”), the element at the r-th row and the c-th column is determined as a non-zero element.

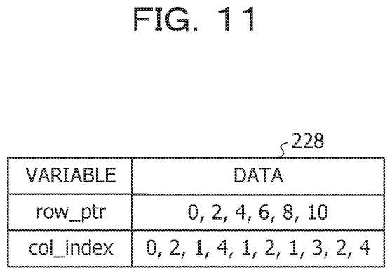

FIG. 11 illustrates a first example of the sparse matrix data 228. The sparse matrix data 228 in FIG. 11 is sparse matrix data in the CSR format generated by the sparse matrix generation program 226 in FIG. 10. The “variable” represents an array included in the sparse matrix information 225, and the “data” represents a value of each element of each array. In this example, as the dimension included in the sparse matrix information 225, 5×5 is used.

Next, a specific example of the sparse matrix generation function zero_element_p(r, c) will be described. For example, in a case where a lower triangular sparse matrix is generated, a function that outputs the logical value “0” when r<c and outputs the logical value “1” with a predetermined probability when r≥c may be used as zero_element_p(r, c). In the lower triangular sparse matrix, all the elements that exist above the main diagonal are zero elements.

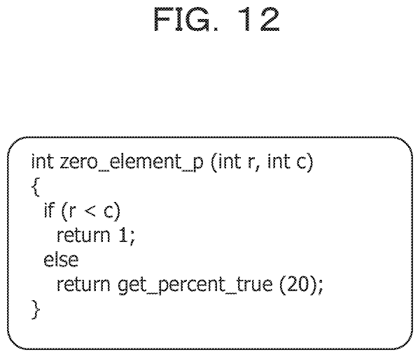

FIG. 12 illustrates an example of the sparse matrix generation function zero_element_p(r, c) that generates a lower triangular sparse matrix. The function get_percent_true(P) in FIG. 12 is a function that outputs the logical value “1” with the probability of P percent and outputs the logical value “0” with the probability of (100-P) percent.

In this example, when r<c, the logical value “1” is output with the probability of 100 percent. Then, when r≥c, the logical value “1” is output with the probability of 20 percent, and the logical value “0” is output with the probability of 80 percent.

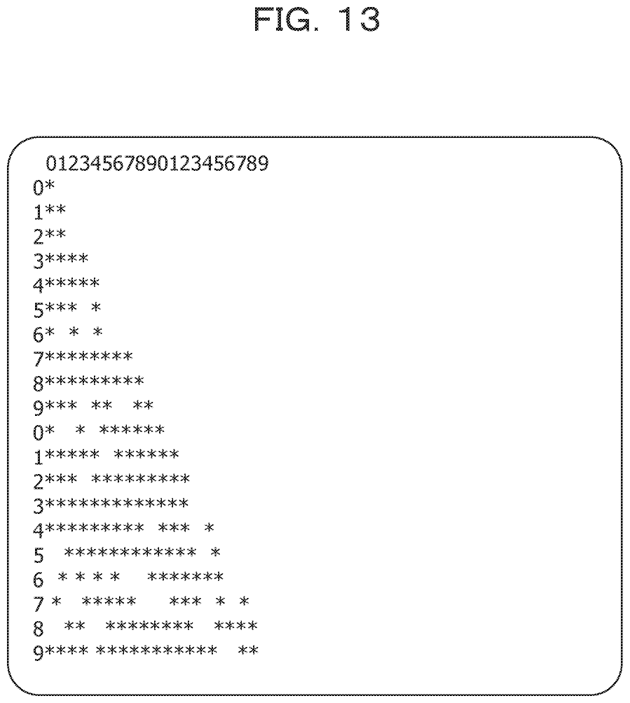

FIG. 13 illustrates an example of a lower triangular sparse matrix generated using zero_element_p(r, c) in FIG. 12. The lower triangular sparse matrix in FIG. 13 is a square matrix including 20 rows and 20 columns, and a symbol “*” represents the position of a non-zero element.

Indexes of rows and columns are described using an integer I (I=0 to 9) twice for convenience. However, in practice, the second integer I indicates a value obtained by adding 10 to the first same integer I. Therefore, actually, the second integers 0 to 9 respectively indicate 10 to 19.

In a case where an upper triangular sparse matrix is generated, a function that outputs the logical value “1” when r>c and outputs the logical value “1” with the predetermined probability when r≤c may be used as zero_element_p(r, c). In the upper triangular sparse matrix, all the elements that exist below the main diagonal are zero elements.

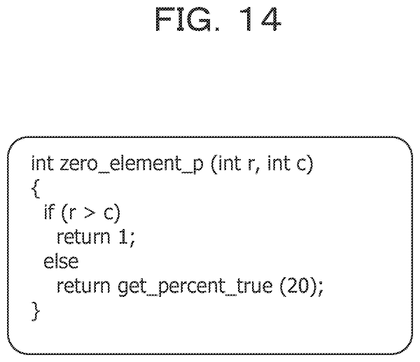

FIG. 14 illustrates an example of the sparse matrix generation function zero_element_p(r, c) that generates an upper triangular sparse matrix. In this example, the logical value “1” is output with the probability of 100 percent when r>c. When r≤c, the logical value “1” is output with the probability of 20 percent, and the logical value “0” is output with the probability of 80 percent.

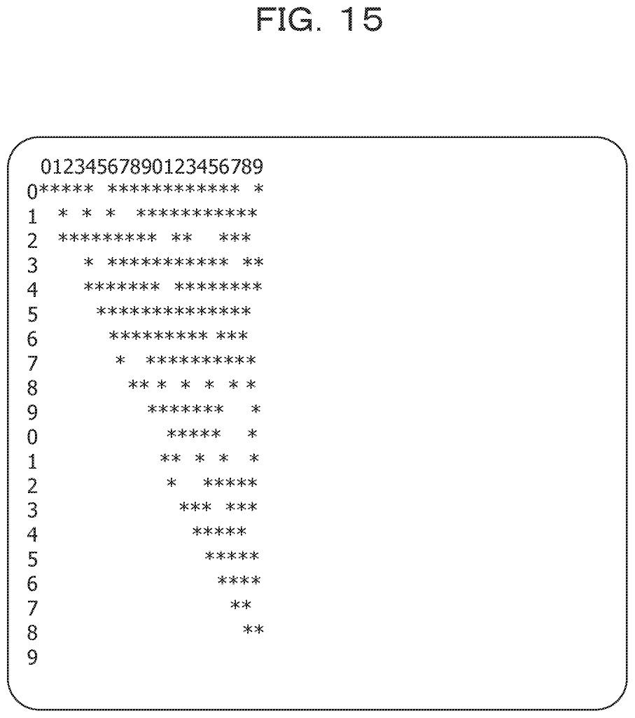

FIG. 15 illustrates an example of an upper triangular sparse matrix generated using zero_element_p(r, c) in FIG. 14. The upper triangular sparse matrix in FIG. 15 is a square matrix including 20 rows and 20 columns, and a symbol “*” represents the position of a non-zero element.

In a case where a random sparse matrix in which zero elements are randomly distributed is generated, a function that outputs the logical value “1” with the predetermined probability with respect to a combination of r and c may be used as zero_element_p(r, c).

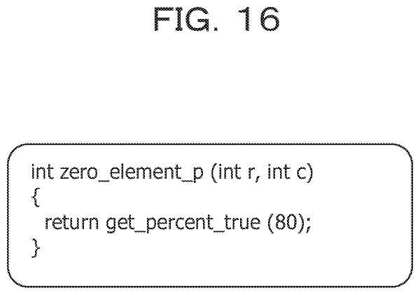

FIG. 16 illustrates an example of the sparse matrix generation function zero_element_p(r, c) that generates a random sparse matrix. In this example, the logical value “1” is output with the probability of 80 percent with respect to the combination of r and c, and the logical value “0” is output with the probability of 20 percent.

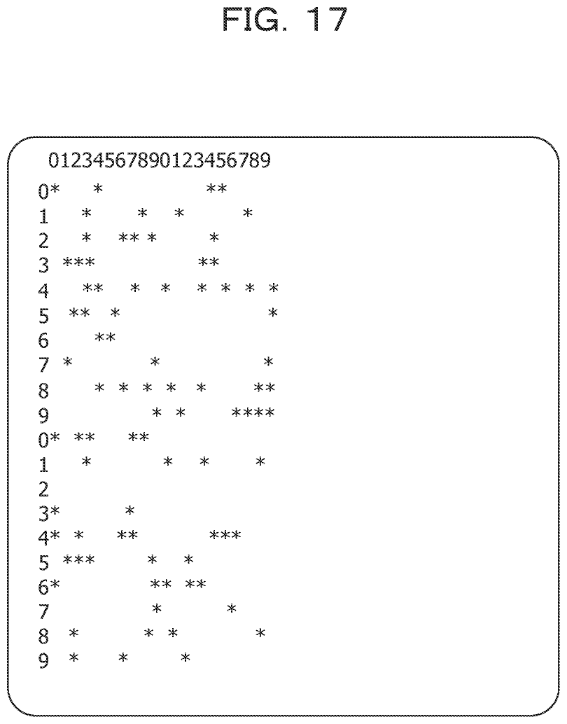

FIG. 17 illustrates an example of a random sparse matrix generated using zero_element_p(r, c) in FIG. 16. The random sparse matrix in FIG. 17 is a square matrix including 20 rows and 20 columns, and a symbol “*” represents the position of a non-zero element.

In a case where a band matrix is generated, a function that outputs the logical value “1” when an absolute value d of a difference between r and c is equal to or more than a predetermined value and outputs the logical value “1” with the predetermined probability when d is smaller than the predetermined value may be used as zero_element_p(r, c). In the band matrix, all elements that exist outside the band region including the main diagonal are zero elements.

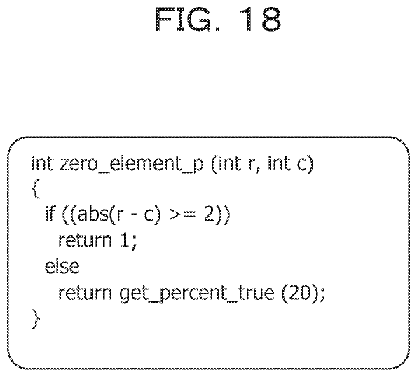

FIG. 18 illustrates an example of the sparse matrix generation function zero_element_p(r, c) that generates a band matrix. The “abs(r-c)” in FIG. 18 represents the absolute value of the difference between r and c. In this example, when abs(r-c) is equal to or more than two, the logical value “1” is output with the probability of 100 percent. when abs(r-c) is smaller than two, the logical value “1” is output with the probability of 20 percent, and the logical value “0” is output with the probability of 80 percent.

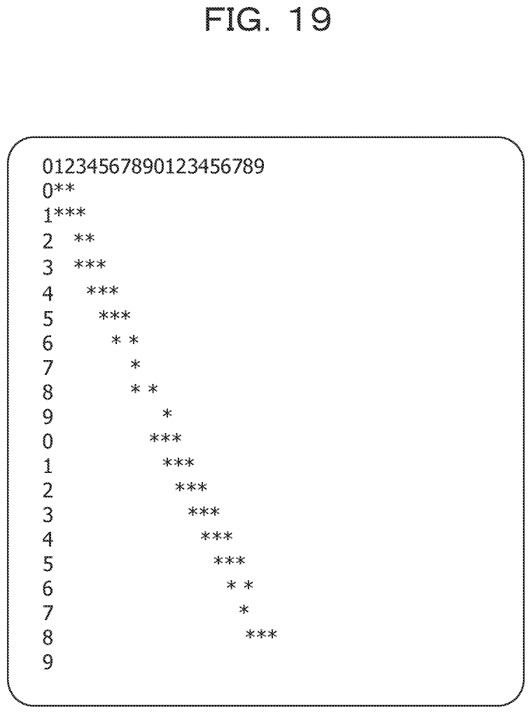

FIG. 19 illustrates an example of a band matrix generated using zero_element_p(r, c) in FIG. 18. The band matrix in FIG. 19 is a square matrix including 20 rows and 20 columns, and a symbol “*” represents the position of a non-zero element.

In this way, by changing implementation of zero_element_p(r, c), the sparse matrix data 228 of a sparse matrix in which non-zero elements are distributed in various modes may be easily generated. By executing the profile acquisition program 227 using these pieces of sparse matrix data 228, the profile information 229 of various sparse matrices may be acquired, and it is possible to verify the difference in the cache miss occurrence status according to the bias of non-zero elements.

As the data format of a sparse matrix of the program 221, a format other than the CSR format may be used. For example, in a case where the Compressed Sparse Column (CSC) format is used, a sparse matrix is represented using an array row_index that indicates an index of a row of a non-zero element and an array col_ptr that indicates a start position of each column in the array row_index.

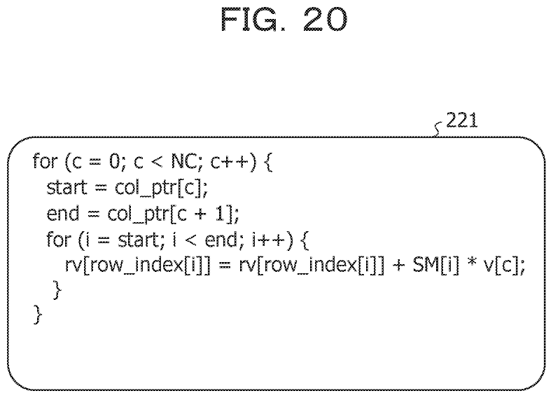

FIG. 20 illustrates a second example of the program 221. The program 221 in FIG. 20 may be obtained by changing the data format of the sparse matrix included in the program 221 in FIG. 3 to the CSC format.

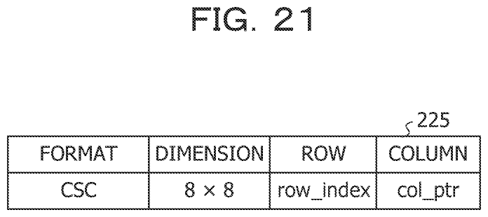

FIG. 21 illustrates a second example of the sparse matrix information 225. The sparse matrix information 225 in FIG. 21 represents a sparse matrix in the CSC format included in the program 221 in FIG. 20. In this example, the format is the CSC, the dimension is 8 x 8, the row is row_index, and the column is col_ptr.

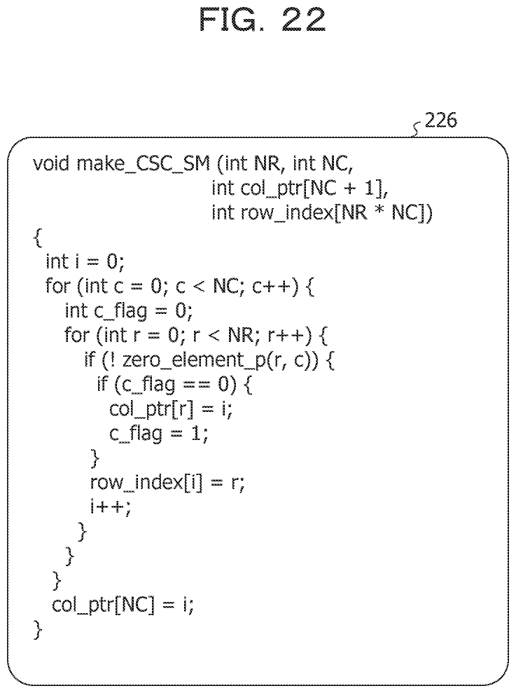

FIG. 22 illustrates a second example of the sparse matrix generation program 226. The sparse matrix generation program 226 in FIG. 22 is a program that generates the sparse matrix data 228 in the CSC format. The sparse matrix data 228 in the CSC format is represented using the array row_index and the array col_ptr.

The sparse matrix generation program 226 in FIG. 22 is a program that determines which one of a zero element or a non-zero element each element in a sparse matrix having NR rows and NC columns is set to, and records positions of non-zero elements in the array row_index and the array col_ptr. The function zero_element_p(r, c) included in the sparse matrix generation program 226 in FIG. 22 is similar to zero_element_p(r, c) in FIG. 10.

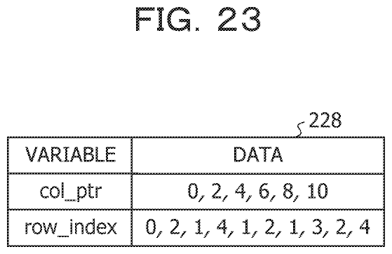

FIG. 23 illustrates a second example of the sparse matrix data 228. The sparse matrix data 228 in FIG. 23 is sparse matrix data in the CSC format generated by the sparse matrix generation program 226 in FIG. 22. In this example, as the dimension included in the sparse matrix information 225, 5×5 is used.

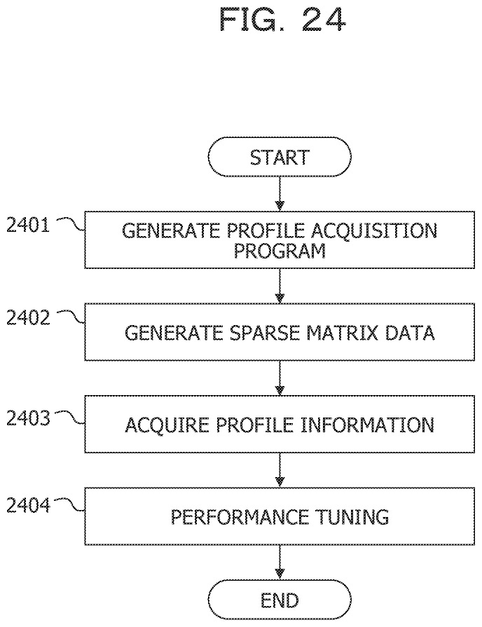

FIG. 24 is a flowchart illustrating an example of tuning processing executed by the information processing device 201 in FIG. 2. First, the conversion unit 211 generates the profile acquisition program 227 by converting the program 221 (step 2401). Then, the generation unit 212 generates the sparse matrix data 228 by executing the sparse matrix generation program 226 using the sparse matrix information 225 (step 2402).

Next, the acquisition unit 213 executes the profile acquisition program 227 using the array information 222, the variable information 223, the cache configuration information 224, and the sparse matrix data 228 so as to acquire the profile information 229 (step 2403). Then, the tuning unit 214 performs performance tuning of the program 221 using the profile information 229 (step 2404).

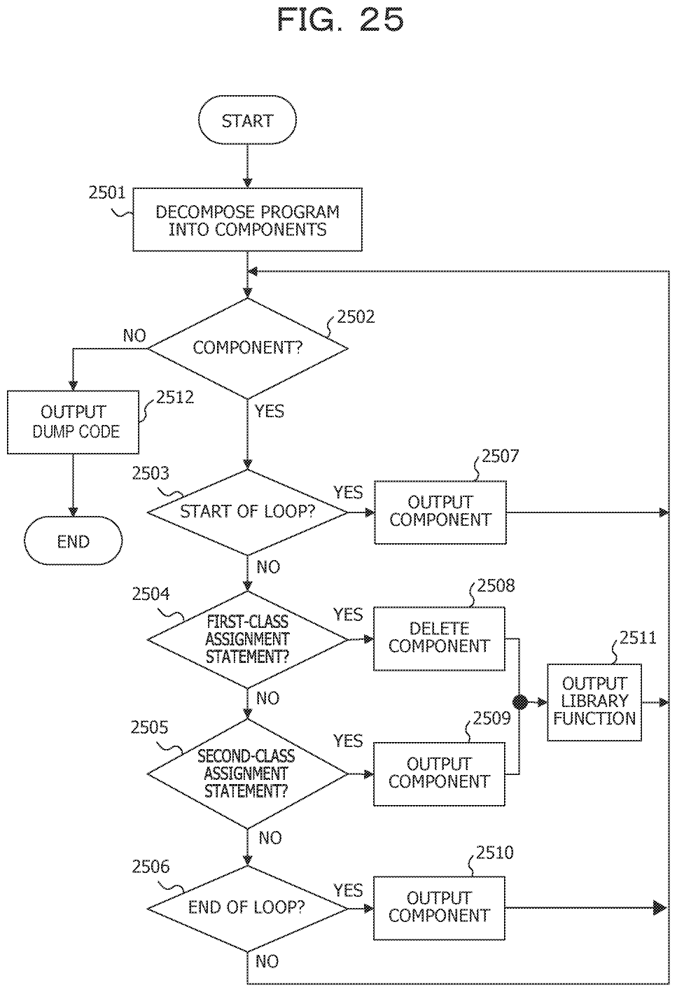

FIG. 25 is a flowchart illustrating an example of program conversion processing in step 2401 in FIG. 24. First, the conversion unit 211 decomposes the program 221 into a plurality of components (step 2501).

Next, the conversion unit 211 checks whether or not an unprocessed component remains (step 2502). In a case where an unprocessed component remains (YES in step 2502), the conversion unit 211 selects a single component and checks whether or not the selected component corresponds to the start of a loop (step 2503).

In a case where the selected component corresponds to the start of a loop (YES in step 2503), the conversion unit 211 outputs the component as a code (step 2507) and repeats the processing in and subsequent to step 2502 on the next component.

In a case where the selected component does not correspond to the start of a loop (NO in step 2503), the conversion unit 211 checks whether or not the selected component corresponds to the first-class assignment statement (step 2504).

In a case where the selected component corresponds to the first-class assignment statement (YES in step 2504), the conversion unit 211 deletes the component (step 2508). Then, the conversion unit 211 outputs a code indicating the processing for executing ACCESS(s, a) for each term that refers to an element of an array included in the component (step 2511) and repeats the processing in and subsequent to step 2502 on the next component.

In a case where the selected component does not correspond to the first-class assignment statement (NO in step 2504), the conversion unit 211 checks whether or not the selected component corresponds to the second-class assignment statement (step 2505).

In a case where the selected component corresponds to the second-class assignment statement (YES in step 2505), the conversion unit 211 outputs the component as a code (step 2509). Then, the conversion unit 211 outputs a code indicating the processing for executing ACCESS(s, a) for each term that refers to an element of an array included in the component (step 2511) and repeats the processing in and subsequent to step 2502 on the next component.

In a case where the selected component does not correspond to the second-class assignment statement (NO in step 2505), the conversion unit 211 checks whether or not the selected component corresponds to the end of a loop (step 2506).

In a case where the selected component corresponds to the end of a loop (YES in step 2506), the conversion unit 211 outputs the component as a code (step 2510) and repeats the processing in and subsequent to step 2502 on the next component.

In a case where the selected component does not correspond to the end of a loop (NO in step 2506), the conversion unit 211 repeats the processing in and subsequent to step 2502 on the next component. In a case where no unprocessed component remains (NO in step 2502), the conversion unit 211 outputs the code DUMP(s) (step 2512).

The configuration of the information processing device 201 in FIG. 2 is merely an example and some components may be omitted or modified depending on the use or conditions of the information processing device 201. For example, in a case where another information processing device generates the profile acquisition program 227, the conversion unit 211 may be omitted. In a case where another information processing device generates the sparse matrix data 228, the generation unit 212 may be omitted. In a case where another information processing device performs performance tuning of the program 221, the tuning unit 214 may be omitted.

The flowcharts illustrated in FIGS. 1, 24, and 25 are merely examples and some processes may be omitted or modified depending on the configuration or conditions of the information processing device 201. For example, in a case where another information processing device generates the profile acquisition program 227, the processing in step 2401 in FIG. 24 may be omitted. In a case where another information processing device generates the sparse matrix data 228, the processing in step 2402 in FIG. 24 may be omitted. In a case where another information processing device performs the performance tuning of the program 221, the processing in step 2404 in FIG. 24 may be omitted.

The programs 221 illustrated in FIGS. 3 and 20 are merely examples, and the program 221 changes according to the sparse matrix processing to be simulated. The array information 222 illustrated in FIG. 4, the variable information 223 illustrated in FIG. 5, and the cache configuration information 224 illustrated in FIG. 6 are merely examples, and these pieces of information change according to the program 221. The components illustrated in FIG. 7 and the profile acquisition program 227 illustrated in FIG. 8 are merely examples, and the components and the profile acquisition program 227 change according to the program 221.

The sparse matrix information 225 illustrated in FIGS. 9 and 21 and the sparse matrix data 228 illustrated in FIGS. 11 and 23 are merely examples, and the sparse matrix information 225 and the sparse matrix data 228 change according to the program 221. The sparse matrix generation programs 226 illustrated in FIGS. 10 and 22 are merely examples, and the sparse matrix data 228 may be generated using another piece of the sparse matrix generation program 226.

The sparse matrix generation functions illustrated in FIGS. 12, 14, 16, and 18 and the sparse matrices illustrated in FIGS. 13, 15, 17, and 19 are merely examples, and another sparse matrix generation function for generating another sparse matrix may be used.

The formulas (1) and (2) are merely examples, and the set number s corresponding to the address a may be obtained using another calculation formula.

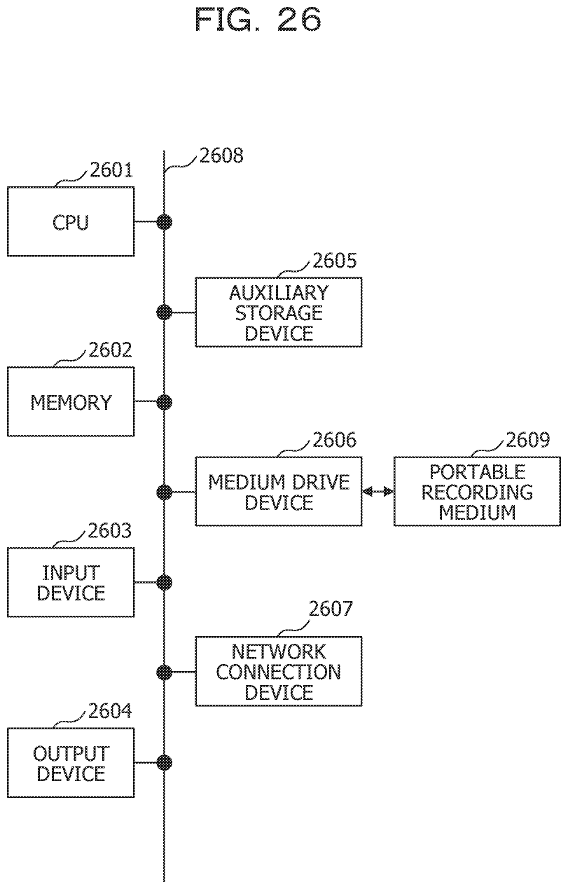

FIG. 26 illustrates a hardware configuration example of the information processing device 201 in FIG. 2. The information processing device 201 in FIG. 26 includes a CPU 2601, a memory 2602, an input device 2603, an output device 2604, an auxiliary storage device 2605, a medium drive device 2606, and a network connection device 2607. These components configure hardware and are connected to each other by a bus 2608.

The memory 2602 is, for example, a semiconductor memory such as a read only memory (ROM), a random access memory (RAM), or a flash memory and stores programs and data used for processing. The memory 2602 may operate as the storage unit 215 in FIG. 2.

The CPU 2601 (processor) operates as the conversion unit 211, the generation unit 212, the acquisition unit 213, and the tuning unit 214 in FIG. 2, for example, by executing the program using the memory 2602.

The input device 2603 is, for example, a keyboard, a pointing device, or the like, and is used to input instructions or information from a user or an operator. The output device 2604 is, for example, a display device, a printer, or the like and is used for an inquiry or an instruction to the user or the operator and an output of a processing result. The processing result may be the profile information 229 and may be the program 221 on which the performance tuning has been performed.

The auxiliary storage device 2605 is, for example, a magnetic disk device, an optical disk device, a magneto-optical disk device, a tape device, or the like. The auxiliary storage device 2605 may be a hard disk drive or a flash memory. The information processing device 201 may store programs and data in the auxiliary storage device 2605 and load these programs and data into the memory 2602 to use. The auxiliary storage device 2605 may operate as the storage unit 215 in FIG. 2.

The medium drive device 2606 drives a portable recording medium 2609 and accesses content recorded in the portable recording medium 2609. The portable recording medium 2609 is a memory device, a flexible disk, an optical disk, a magneto-optical disk, or the like. The portable recording medium 2609 may be a Compact Disk Read Only Memory (CD-ROM), a Digital Versatile Disk (DVD), a Universal Serial Bus (USB) memory, or the like. The user or the operator may store programs and data in this portable recording medium 2609 and load these programs and data into the memory 2602 to use.

As described above, a computer-readable recording medium in which the programs and data used for processing are stored includes a physical (non-transitory) recording medium such as the memory 2602, the auxiliary storage device 2605, or the portable recording medium 2609.

The network connection device 2607 is a communication interface circuit that is connected to the communication network and performs data conversion associated with communication. The information processing device 201 may receive programs and data from an external device via the network connection device 2607 and load these programs and data into the memory 2602 to use.

Note that the information processing device 201 does not need to include all the components in FIG. 26, and some components may be omitted according to the use or conditions of the information processing device 201. For example, in a case where an interface with the user or the operator is unnecessary, the input device 2603 and the output device 2604 may be omitted. In a case where the portable recording medium 2609 or the communication network is not used, the medium drive device 2606 or the network connection device 2607 may be omitted.

While the disclosed embodiment and the advantages thereof have been described in detail, those skilled in the art will be able to make various modifications, additions, and omissions without departing from the scope of the embodiment as explicitly set forth in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information acquisition program for causing a computer to execute a process, the process comprising:
receiving sparse matrix data that indicates a position of a non-zero element in a sparse matrix that is referred in sparse matrix processing included in a target program; and
acquiring, using the sparse matrix data, cache access information that indicates an access status to a cache memory occurred in the sparse matrix processing.

2. The non-transitory computer-readable recording medium according to claim 1, wherein
the cache access information includes information that indicates a memory access in which a cache miss occurs in the cache memory among a plurality of memory accesses occurred in the sparse matrix processing.

3. The non-transitory computer-readable recording medium according to claim 1, wherein
the sparse matrix data is generated using a function that determines which one of a non-zero element or a zero element each of a plurality of elements included in the sparse matrix is set to.

4. The non-transitory computer-readable recording medium according to claim 1, wherein
the information acquisition program is generated by replacing a first code that refers to the non-zero element in the sparse matrix included in the target program into a second code that simulates an access to the cache memory.

5. An information acquisition method, comprising:
receiving, by a computer, sparse matrix data that indicates a position of a non-zero element in a sparse matrix that is referred in sparse matrix processing included in a target program; and
acquiring, using the sparse matrix data, cache access information that indicates an access status to a cache memory occurred in the sparse matrix processing.

6. The information acquisition method according to claim 5, wherein
the cache access information includes information that indicates a memory access in which a cache miss occurs in the cache memory among a plurality of memory accesses occurred in the sparse matrix processing.

7. The information acquisition method according to claim 5, wherein
the sparse matrix data is generated using a function that determines which one of a non-zero element or a zero element each of a plurality of elements included in the sparse matrix is set to.

8. The information acquisition method according to claim 5, wherein
the information acquisition program is generated by replacing a first code that refers to the non-zero element in the sparse matrix included in the target program into a second code that simulates an access to the cache memory.

9. An information processing device, comprising:
a memory; and
a processor coupled to the memory and the processor configure to:
receive sparse matrix data that indicates a position of a non-zero element in a sparse matrix that is referred in sparse matrix processing included in a target program; and
acquire, using the sparse matrix data, cache access information that indicates an access status to a cache memory occurred in the sparse matrix processing.

10. The information processing device according to claim 9, wherein
the cache access information includes information that indicates a memory access in which a cache miss occurs in the cache memory among a plurality of memory accesses occurred in the sparse matrix processing.

11. The information processing device according to claim 9, wherein
the sparse matrix data is generated using a function that determines which one of a non-zero element or a zero element each of a plurality of elements included in the sparse matrix is set to.

12. The information processing device according to claim 9, wherein
the information acquisition program is generated by replacing a first code that refers to the non-zero element in the sparse matrix included in the target program into a second code that simulates an access to the cache memory.
